(19) United States
(12) Patent Application Publication
(10) Pub. No.: US 2014/0251212 A1
(43) Pub. Date: Sep. 11, 2014

(54) HOPPER AND THERMAL SPRAYING APPARATUS

(71) Applicant: Tokyo Electron Limited, Tokyo (JP)

(72) Inventors: Yoshiyuki KOBAYASHI, Miyagi (JP); Satoshi TAGA, Miyagi (JP)

(73) Assignee: Tokyo Electron Limited, Tokyo (JP)

(21) Appl. No.: 14/187,415

(22) Filed: Feb. 24, 2014

(30) Foreign Application Priority Data
Mar. 7, 2013 (JP) 2013-045858

(51) Int. Cl. B05B 17/06

(52) U.S. Cl. CPC B05B 17/0676
USPC 118/612; 222/196

(57) ABSTRACT

A hopper includes a container to contain a powdered material having a diameter of 0.1 through 10 micrometers, a pressure control part configured to create a periodic pressure difference inside the container, and a vibration exciter configured to vibrate the container. The container has a hole provided in a bottom thereof to feed the powdered material downward.

### CROSS-REFERENCE TO RELATED APPLICATIONS

This patent application is based upon and claims the benefit of priority of Japanese Patent Application No. 2013-45858, filed on Mar. 7, 2013, the entire contents of which are incorporated herein by reference.

### BACKGROUND OF THE INVENTION

1. Field of the Invention

The present invention relates to a hopper and a thermal spraying apparatus.

2. Description of the Related Art

A material feeding device that sends a material contained in a container forth according to a necessary amount is called a hopper. A hopper shakes off the powdered material contained in the container. A thermal spraying apparatus melts the powdered material shaken from the hopper by heating, and forms a sprayed coating on an object to be sprayed by spraying the melted material to the object to be sprayed. For example, Japanese Laid-Open Patent Application Publication No. 2012-201890 discloses a cold thermal spraying technology that performs thermal spraying under an aerial environment.

The sprayed coating is porous in general, and the physical property is inferior to a pure material. To improve this point, it is necessary to form a dense film by thermal spraying.

However, the powdered material is granulated powder having a grain diameter of tens of micrometers, and some part remains without being melted in melting the powdered material by heating because the grain diameter is too large. Accordingly, in order to form a dense film by thermal spraying, feeding a fine-grained material smaller than the general granulated powder in grain diameter is important.

In the meantime, when using the fine-grained material, holes to shake off the material that are provided in the hopper may be clogged with the fine-grained material, and a spitting phenomenon may occur.

### SUMMARY OF THE INVENTION

Embodiments of the present invention provide a novel and useful film deposition apparatus and film deposition method solving one or more of the problems discussed above.

More specifically, in response to the above-mentioned problem, an aspect of embodiments of the present invention provides a hopper and a thermal spraying apparatus capable of feeding a fine-grained material.

According to one embodiment of the present invention, there is provided a hopper that includes a container to contain a powdered material having a diameter of 0.1 through 10 micrometers, a pressure control part configured to create a periodic pressure difference inside the container, and a vibration exciter configured to vibrate the container. The container has a hole provided in a bottom thereof to feed the powdered material downward.

According to another embodiment of the present invention, there is provided a thermal spraying apparatus that includes a container to contain a powdered material having a diameter of 0.1 through 10 micrometers. The container has a hole provided in a bottom thereof to feed the powdered material downward. The thermal spraying apparatus further includes a pressure control part configured to create a periodic pressure difference inside the container, a vibration exciter configured to vibrate the container, a processing chamber to hold an object to be sprayed therein and provided below the container, a material feeding part communicated with the hole of the container and an inside of the chamber, and a heating part communicated with the inside of the chamber and configured to supply a heated gas to the powdered material fed from the container into the processing chamber through the material feeding part to melt and spray the powdered material onto the object to be sprayed.

Additional objects and advantages of the embodiments are set forth in part in the description which follows, and in part will become obvious from the description, or may be learned by practice of the invention. The objects and advantages of the invention will be realized and attained by means of the elements and combinations particularly pointed out in the appended claims. It is to be understood that both the foregoing general description and the following detailed description are exemplary and explanatory and are not restrictive of the invention as claimed.

### BRIEF DESCRIPTION OF THE DRAWINGS

FIGS. 1A and 1B are skeletal configuration diagrams of a thermal spraying apparatus according to an embodiment;

FIG. 2 is a cross-sectional diagram of a thermal spraying apparatus according to an embodiment;

FIG. 3 is a table illustrating a relationship between a grain diameter of a powdered material and a falling state according to an embodiment;

FIG. 4 is a flowchart illustrating a thermal spraying process according to an embodiment;

FIG. 5 is an example of pressure control in a container of a hopper according to an embodiment;

FIGS. 6A and 6B are configuration example of a pressure control part according to an embodiment;

FIGS. 7A through 7C are an example of thermal spraying of a fritted glass according to an embodiment; and

FIG. 8 is another example of a thermal spraying apparatus according to an embodiment.

### DETAILED DESCRIPTION OF THE PREFERRED EMBODIMENTS

A description is given below of an embodiment of the present invention, with reference to the drawings. In the present specification and the drawings, with respect to the substantially same configuration, overlapped descriptions are omitted by attaching the same numerals. In the following description, respective units can be converted under the transformation relationship of 1 atm=760 Torr=1.01325×10⁵ Pa.

[Configuration of Thermal Spraying Apparatus]

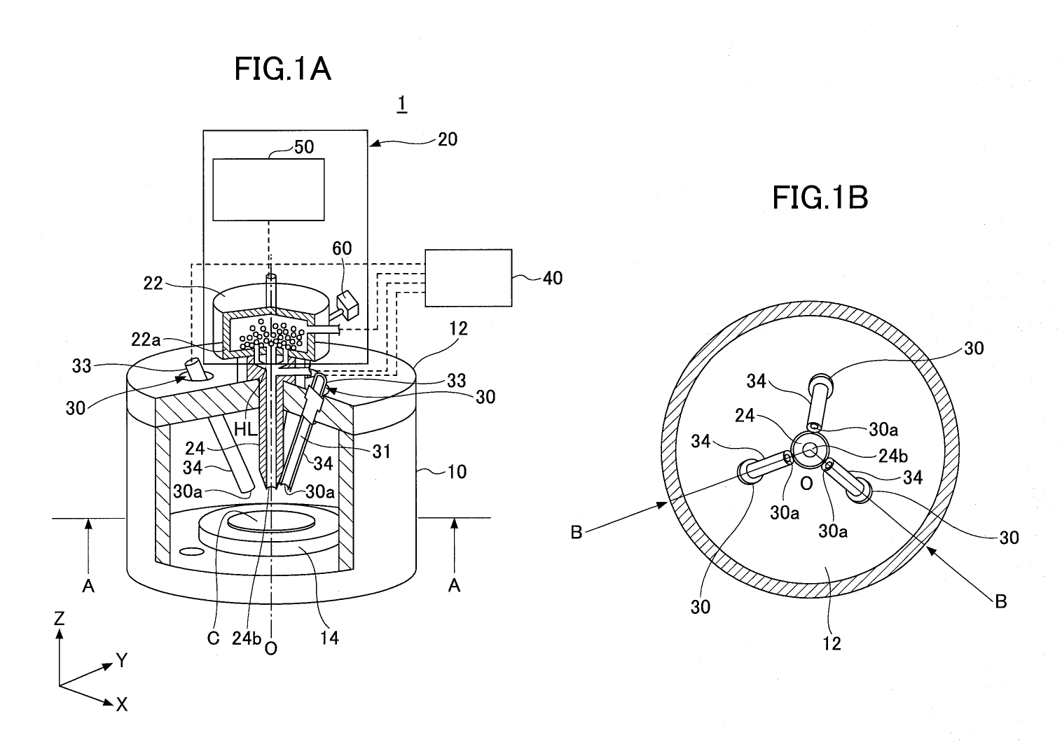

To begin with, a description is given below of an outlined configuration of a thermal spraying apparatus according to an embodiment with reference to FIGS. 1A and 1B. FIG. 1A is an outline configuration diagram of the thermal spraying apparatus of the embodiment. FIG. 1B is an A-A plan view of FIG. 1A, and illustrates a ceiling side of the inside of the thermal spraying apparatus when seen from the lower side in a planar perspective.

The thermal spraying apparatus 1 of the present embodiment includes a processing chamber 10 and a hopper 20. The processing chamber 10 is provided below the hopper 20. The processing chamber 10 and the hopper 120 are connected with each other through a material feeding part 24.

The thermal spraying apparatus 1 illustrated in FIG. 1A includes the cylindrical processing chamber 10 surrounding the axis 0. In the processing chamber 10, a spraying coating is formed on an object (i.e., object to be sprayed) by thermal spraying. The processing chamber 10 is open at the ceiling part, and a lid body 12 is installed at the opening, by which the opening is closed. In FIG. 1A, apart of a side wall of the processing chamber 10 and a part of the lid body 12 are omitted so as to show the inside for convenience of explanation, but in fact, the inside of the processing chamber 10 is sealed. A stage 14 is provided on the bottom of the processing chamber 10. An object C is placed on the stage 14.

A hopper 20 is attached to the upper side of the lid body 12. Moreover, three heating parts 30 are fixed to the lid body 12, penetrating the lid body 12 from the upper side thereof. The hopper 20 includes a container 22, a pressure control part 50 and a vibration exciter 60. The hopper 20 is what is called a material feeding device that feeds a material contained in the container 22 depending on a necessary amount into the processing chamber 10. The material inside the container 22 is introduced into the processing chamber 10 toward the object to be sprayed C through the material feeding part 24. A detailed description is given later of a configuration of the hopper 20.

As illustrated in FIGS. 1A and 1B, the heating parts 30 are formed into a rod-like shape, and three of the heating parts 30 are provided at equal angle intervals of 120 degrees in a circumferential direction. However, two or more heating parts 30 may be provided at equal intervals in the circumferential direction.

A gas supply source 40 supplies an argon gas to the processing chamber 10, the material feeding part 24 and the heating parts 30. The argon gas supplied into the processing chamber 10 is an environmental control gas, and prevents impurities such as nitrogen, oxygen, moisture and the like from mixing into a sprayed coating. The argon gas supplied to the material feeding part 24 is a carrier gas, and carries the material inside the container 22 into the processing chamber 10. The argon gas supplied to the heating parts 30 is heated when passing through the heating parts 30, and is supplied to the processing chamber 10 as a heated gas. Tips 30a of the heating parts 30 are arranged at a slant so as to supply the heating gas to a falling path to which the material falls from a tip 24b of the material feeding part 24. This causes the material supplied into the processing chamber 10 from the tip 24b of the material feeding part 24 to be melted by the heated gas blown from the tips 30a of the heating parts 30. This serves to form the sprayed coating on the object to be sprayed C.

The stage 14 is controllable in XY axes directions and a Z axis direction. By rotation of the stage 14, the sprayed coating can be deposited on the object to be sprayed C in a circumferential direction. By moving the stage 14 in the XY directions, the object to be sprayed C may be sprayed while scanning the object to be sprayed C, or the object to be sprayed C may be moved to a spraying point. The thermal spraying may be performed by causing the stage 14 to make sun-and-planet motion. Moreover, the stage 14 can be arbitrarily lifted and lowered in the Z axis direction in addition to the motion and rotation in the horizontal direction.

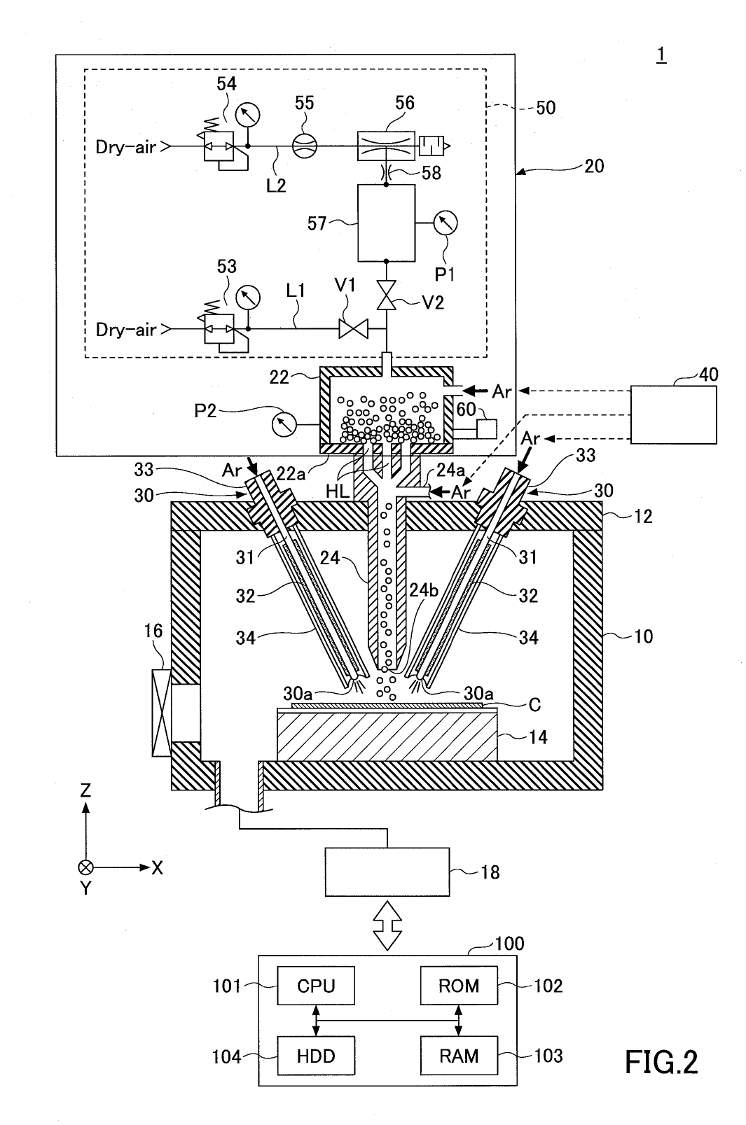

A further detailed description is given of the hopper 20 and the thermal spraying apparatus 1 to which the hopper 20 is attached with reference to FIG. 2. FIG. 2 is a B-B cross-sectional diagram of FIG. 1B. The pressure control part 50 and the vibration exciter 60 are connected to the container 22 of the hopper 20. FIG. 2 illustrates an inner configuration of the pressure control part 50.

The container 22 contains a powdered material having a diameter of 0.1 through 10 μm. In the present embodiment, the container 22 contains particles of aluminum, but the container 22 can contain various materials according to an intended purpose such as fine alumina (Al₂O₃) having a diameter of 0.1 through 10 μm and particles of other metals and the like, without being limited to the present embodiment. The inside of the container 22 is filled with an argon gas. The argon gas is supplied from the gas supply source 40. The argon gas functions as an environment control gas of the inside of the container 22, by which the spray coating of aluminum having a high purity without containing nitrogen, oxygen, and hydrogen in the atmosphere can be deposited. Here, the argon gas is an example of an inactive gas, and a xenon gas and the like can be used instead of the argon gas. Furthermore, dry air can be introduced into the container 22 instead of introducing the inactive gas into the container 22.

A gate valve 16 is provided in the side wall of the processing chamber 10, and the object to be sprayed C can be transferred into/from the processing chamber 10 by opening/closing the gate valve 16. The inside of the processing chamber 10 maybe evacuated to a predetermined vacuum pressure by an exhaust device 18 (see FIG. 2). This makes it possible to perform the thermal spraying under a reduced-pressure environment. This can prevent the oxygen and/or the nitrogen in the air from mixing into the sprayed coating.

A plurality of holes HL is formed in a baffle 22a that constitutes the bottom of the container 22. The pressure control part 50 controls the pressure of the inside of the container 22 so as to change the pressure into a positive pressure and a negative pressure periodically. The vibration exciter 60 provides vibrations for the container 22. In this manner, the hopper 20 of the present embodiment shakes off the material to the plurality of holes HL provided in the container 22, and feeds the material to the inside of the material feeding part 24 communicated with the plurality of holes HL without delay by controlling the pressure inside the container 22 so as to periodically change the pressure into the positive pressure and the negative pressure and by providing the vibrations. Here, an amount of the material fed from the container 22 is controlled by a diameter φ, a length, and the number of the plurality of holes HL formed in the baffle 22a.

An introduction port 24a to introduce a carrier gas is provided in the material feeding part 24. The argon gas supplied from the gas supply source 40 is introduced to the inside of the material feeding part 24 from the introduction port 24a. The particles of aluminum are carried into the processing chamber 10 by making the argon gas as a carrier gas. The particles of aluminum are fed from the tip 24b of the material feeding part 24 to the upper side of the object to be sprayed.

Heaters 32 are wound around tubular gas pipes 31 of the heating parts 30. Glass tubes 34 formed of quartz glass and the like are provided around the heaters 32. The base of the glass tubes 31 are supported by supporting parts 33 constituted of ceramics and the like. The supporting parts 33 penetrate the lid body 12 at a slant so that the tips 30a of the heating parts 30 are located in the vicinity of the tip 24b of the material feeding part 24.

The argon gas supplied from the gas supply source 40 is introduced to the heating parts 30. The argon gas is heated by the heaters 32 when passing the gas tubes 31, and becomes the heated gas. The heated gas is blown from the tips 31b of the heating parts 30, melts the particles of aluminum fed to the upper side of the object to be sprayed, and sprays the melted aluminum onto the object to be sprayed. By doing this, a dense sprayed coating made of the particles of aluminum is formed on the object to be sprayed.

A control part 100 includes a CPU (Central Processing Unit) 101, a ROM (Read Only Memory) 102, a RAM (Random Access Memory) 103, and an HDD (Hard Disk Drive) 104. The CPU 101 implements a spraying process in accordance with a variety of recipes stored in the ROM 102, the RAM 103 or the HDD 104. The recipe stores information about control information of pressurization and depressurization or a switching cycle of a solenoid valve performed by the pressure control part 50, a vibration cycle of the vibration exciter 60, a temperature of the heater 32, an amount of the argon gas supply, evacuation of the processing chamber 10 and the like.

As mentioned above, a description was given of the overall configuration of the thermal spraying apparatus 1 of the present embodiment. Next, a description is given below of an inner configuration of the pressure control part 50 of the hopper 20 that constitutes a part of the thermal spraying apparatus 1, with reference to FIG. 2.

[Inner Configuration of Pressure Control Part]

In the present embodiment, the pressure control part 50 controls the pressure in the container 22 so as to periodically make the pressure positive or negative by periodically allowing a fluid to flow into the container 22 and to flow out of the container 22.

The pressure control part 50 includes solenoid valves V1, V2, regulators 53, 54, a flow meter 55, an ejector 56, a pressure adjusting container 57, a filter 58, and pressure gauges P1, P2.

The regulators 53, 54 control a pressure. The flow meter 55 measures a flow rate of dry air. The pressure gauge P1 measures a pressure inside the pressure adjusting container 57. The pressure gauge P2 measures a pressure inside the container 22. The ejector 56 accelerates the dry air in a pipe L2. The dry air may be replaced by an inactive gas such as argon gas and the like. An environment of the thermal spraying is more easily controlled when using the argon gas than using the dry air because the argon gas does not contain nitrogen, oxygen or hydrogen.

The dry air is continued to be supplied into a pipe L1 and the pipe L2. The regulator 53 is set at (760+40) Torr, and the regulator 54 is set at (760−40) Torr. In this state, the solenoid valve V1 is opened, and the solenoid valve V2 is closed. As a result, the dry air flows from the pipe L1 to the inside of the container 22. This pressurizes the inside of the container 22 to (760+40) Torr, and the pressure goes into a positive state.

The dry air having flown through the pipe L2 is accelerated in the ejector 56. Because of this, a gas in the pressure adjusting container 57 flows into the ejector 56 side by venturi effect, and the internal pressure of the pressure adjusting container 57 is decreased. The filter 58 is provided to prevent the material from being drawn in toward the ejector 56 side with the gas at this time. In this state, when the solenoid valve V2 is opened and the solenoid valve V1 is closed, the internal pressure of the container 22 is reduced to (760−40) Torr, and becomes negative.

The pressure control part 50 switches between the solenoid valves V1 and V2 based on instructions of the control part 100. For example, when controlling the internal pressure of the container 22 by making the internal pressure positive and negative at a cycle of 1 Hz, the pressure control part 50 switches between opening and closing of the solenoid valves V1, V2 every 0.5 seconds.

The pressure control part 50 may set the pressure of the regulator 53 at a predetermined value in a range from (760+30) through (760+200) Torr. Moreover, the pressure control part 50 may set the pressure of the regulator 54 at a predetermined value in a range from (760−30) through (760−200) Torr. This allows the internal pressure of the container 22 to alternately switch between the positive pressure in a range from (760+30) through (760+200) Torr and the negative pressure in a range from (760−30) through (760−200) Torr.

Furthermore, the pressure control part 50 preferably sets the pressure of the regulator 53 at (760+40) through (760+60) Torr. In addition, the pressure control part 50 preferably sets the pressure of the regulator 54 at (760−40) through (760−60) Torr. Moreover, the pressure control part 50 may control the internal pressure of the container 22 so as to make the internal pressure positive and negative at a cycle of 1 through 10 Hz. In this case, the pressure control part 50 switches between opening and closing of the solenoid valves V1, V2 at the timing of ½ of the set cycle.

Furthermore, the vibration exciter 60 may vibrate at a cycle of 1 through 10 Hz, and preferably may vibrate at a cycle of 5 through 50 Hz.

As described above, the pressure control part 50 controls the switching to let the gas such as the dry air and the argon gas in or out of the container 22, and the flow rate and the flow speed of the gas. This makes it possible to control the pressure inside the container 22 so as to make the pressure periodically positive and negative.

When the powdered material has been granulated powders that have a grain diameter of tens of micrometers, an insufficiently melted portion has remained in melting the material by heating because the grain has been too large, and the insufficiently melted portion has prevented a dense film from being formed by thermal spraying. Accordingly, in order to form a dense film by thermal spraying, feeding the material of particles is important.

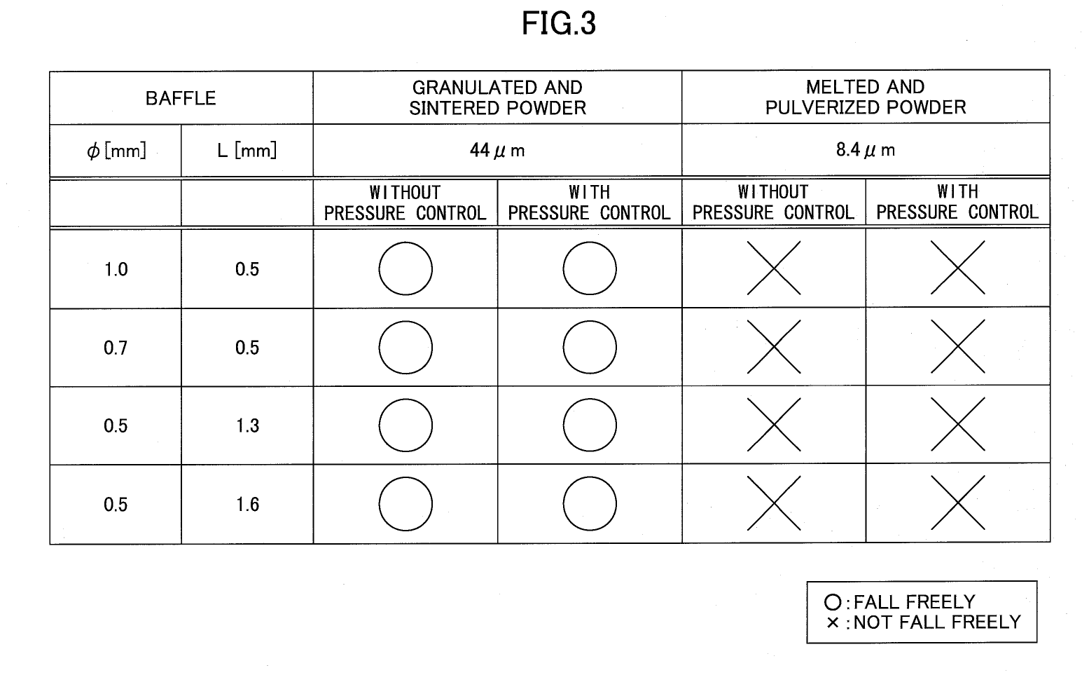

In the meantime, when the material of the particles is used, holes to shake off the materials that are provided in the hopper are clogged. A description is given below of a state of the powdered material of falling freely from the holes HL with reference to FIG. 3. FIG. 3 illustrates an example of using two different grain diameters of alumina powders. One was a granulated and sintered powder having a grain diameter of about 44 μm, and the other was a melted and pulverized powder having a grain diameter of about 8.4 μm. In addition, four kinds of baffles 22a different in diameter φ and length L were used.

As a result, in any baffles 22a ((φ=1.0, L=0.5), (φ=0.7, L=0.5), (φ=0.5, L=1.3), (φ=0.5, L=1.6) (unit is mm), the granulated and sintered powder having the grain diameter of about 44 μm freely fell from the holes HL. On the other hand, in any baffles 22a, the melted and pulverized powder having the grain diameter of about 8.4 μm did not freely fall from the holes HL.

However, in the thermal spraying apparatus 1 of the present embodiment, the pressure control part 50 controls the internal pressure of the container 22 so as to make the internal pressure periodically positive and negative, and the vibration exciter 60 vibrates the container 22. This allows the material contained in the container 22 to be shaken from the holes HL provided in the container 22 even if the diameter of the fine-grained material is 0.1 through 10 μm. As a result, when the heating parts 30 melt the fine-grained material, an insufficiently melted portion is not generated in the material. Hence, according to the thermal spraying apparatus of the present embodiment, a dense sprayed coating can be formed by spraying the fine-grained material melted by heated gas on the object to be sprayed.

[Spraying Process]

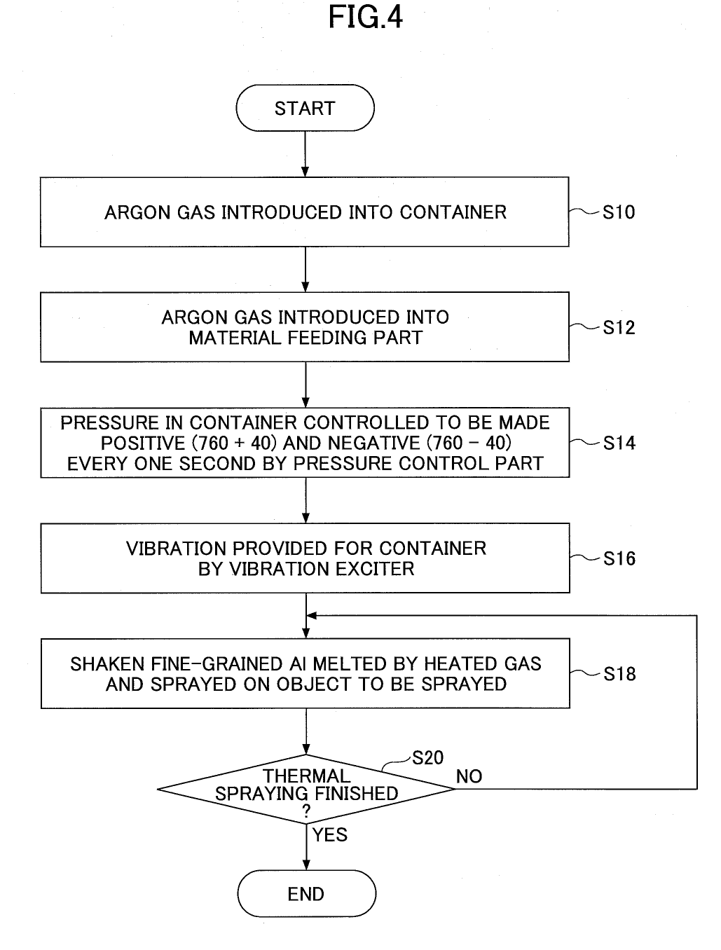

Next, a description is given below of a thermal spraying process of the present embodiment with reference to FIG. 4. FIG. 4 is a flowchart illustrating a thermal spraying process of the present embodiment.

To begin with, an argon gas is introduced from the gas supply source 40 into the container 22 (step S10). The argon serves to prevent impurities such as nitrogen, oxygen, moisture and the like from mixing into a spray coating when spraying.

Next, an argon gas is introduced into the material feeding part 24 from the gas supply source 40 (step S12). The argon gas is a carrier gas, and carries a powdered material shaken from the container 22 to the processing chamber 10. Here, a sequence of step S10 and step S12 may be exchanged, or step S10 and step S12 may be performed at the same time.

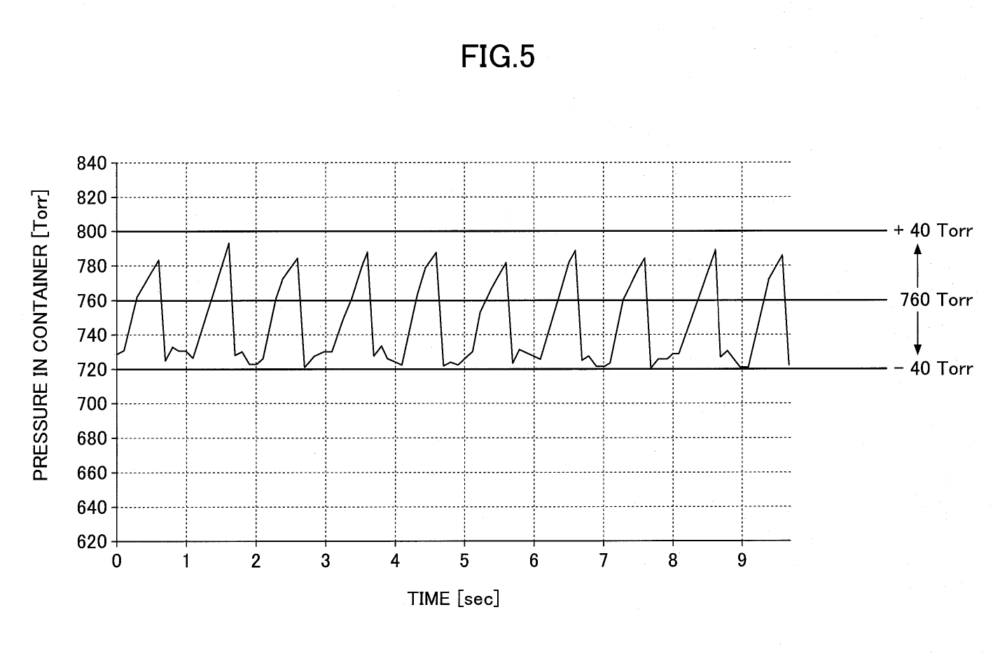

Next, the pressure control part 50 controls the internal pressure of the container 22 to alternately change the internal pressure to a positive pressure of (760+40) Torr and a negative pressure of (760−40) Torr at a cycle of one second (step S14). FIG. 5 illustrates the control performed by the pressure control part 50. This illustrates that the internal pressure of the container 22 is controlled to alternately become the positive pressure of (760+40) Torr and the negative pressure of (760−40) Torr at a cycle of one second by switching the solenoid valves V1, V2 at a cycle of 0.5 seconds. Moreover, the vibration exciter 60 adds vibrations to the container 22 (step S16). Here, a processing sequence of steps S14 and S16 may be simultaneous, or either of the steps may be performed first.

Next, the heating parts 30 melt fine-grained aluminum shaken from the container 22 by heated gas, and spray the melted aluminum onto an object to be sprayed (step S18). Next, the control part 100 determines whether the thermal spraying has finished (step S20). If the thermal spraying has not finished, returning back to step S18, the thermal spraying is continued while moving the stage 14. If the thermal spraying has finished, the present process is finished.

As mentioned above, according to the thermal spraying apparatus 1 of the present embodiment, the hopper 20 capable of shaking off the fine-grained material is provided. More specifically, according to the hopper 20 of the present embodiment, the pressure control part 50 creates a periodic pressure difference inside the container 22, and the vibration exciter 60 provides the container 22 with vibrations. This makes it possible to shake the fine-grained material from the holes HL of the container 22. The shaken powdered material is conveyed to the processing chamber 10 of the present embodiment. At this time, the powdered material is completely melted in the heating parts 30 because the powdered material is made of particles having a diameter of 0.1 through 10 μm. Because the material is fully melted, by spraying the material onto the object to be sprayed, a dense film can be formed on the object to be sprayed. Moreover, the material can be handled in a form of powders, not in a form of a composite material of a wire, a rod, nor a paste. Hence, a cost of the material can be reduced. Furthermore, a film deposition becomes easy because each of the processes of depositing a film and annealing can be performed in the same processing chamber 10. In addition, because a coating is formed by the thermal spraying, a film deposition on an object to be sprayed that is not flat is possible, which can be utilized in various occasions.

[Modification of Thermal Spraying Apparatus]

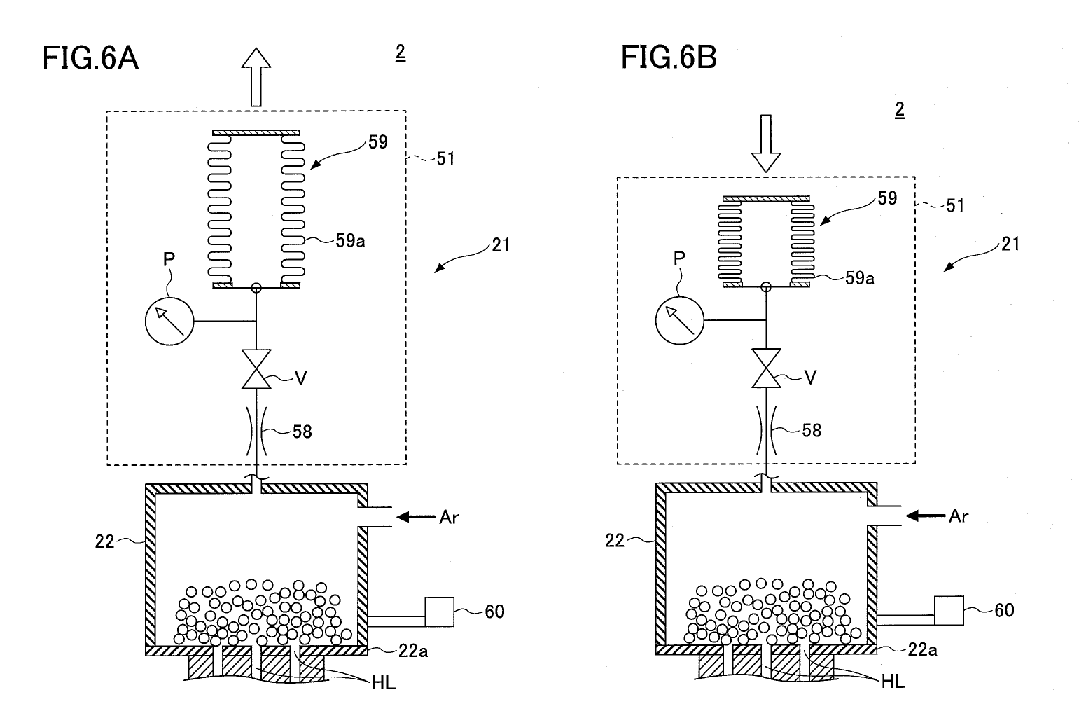

Next, a description is given below of a thermal spraying apparatus 2 of a modification of the present embodiment, with reference to FIGS. 6A and 6B. FIGS. 6A and 6B illustrate a configuration and operation of a hopper 21 of the modification of the present embodiment. In FIG. 6A, the processing chamber 10 and the like below the hopper 21 in the thermal spraying apparatus 2 are omitted.

The hopper 21 of the modification differs from the hopper 20 of the present embodiment only in terms of a configuration and operation of a pressure control part 51. More specifically, the pressure control part 50 of the present embodiment provides a periodic pressure difference for the inside of the container 22 by controlling the switching to allow the dry air to flow into/out of the container 20, and the flow rate and flow speed of the dry air. In contrast, the pressure control part 51 of the modification provides a periodic pressure difference for the inside of the container 22 by changing a cubic volume of the container 22.

For example, the hopper 21 illustrated in FIGS. 6A and 6B includes a pump-like member 59 that is communicated with the inside of the container 22. The pump-like member 59 is closed by bellows 59a to form an internal space, and is configured to be extendable. When the pump-like member 59 is pushed down and the bellows 59a is contracted to go into a state of FIG. 6B from a state of FIG. 6A, the inside of the container 22 communicated with the pump-like member 59a goes into a pressurization state. Moreover, when the bellows 59a is extended to go into a state of FIG. 6A from a state of FIG. 6B, the inside of the container 22 communicated with the pump-like member 59 goes into a decompression state. Accordingly, in the present modification, by repeating the pressurization state of FIG. 6B and the decompression state of FIG. 6A at a cycle of 1 through 10 Hz, a difference in pressure can be provided for the inside of the container 22. Furthermore, by providing vibrations for the container 22 by the vibration exciter 60 in parallel with this, the fine-grained material can be shaken from the holes HL in the present modification. This makes it possible to deposit a dense film on the object to be sprayed. Here, the pressure control part 50 disclosed in the above embodiment and the pressure control part 51 of the modification may be combined with each other.

### FIRST EXAMPLE OF APPLICATION

In the thermal spraying apparatus 1, 2 of the above embodiment and the modification, the thermal spraying is performed by using the material made of the particles including the metals of aluminum, alumina or the like. This thermal spraying can be utilized when a base member of an electrode used in a plasma treatment apparatus and the like is not a metal and a sprayed coating of aluminum (an electrode layer) is formed on the base member, or when a sprayed coating of alumina is formed on the base member of the electrode. However, the thermal spraying apparatus 1, 2 of the present embodiment and the modification can be applied even when spraying another material.

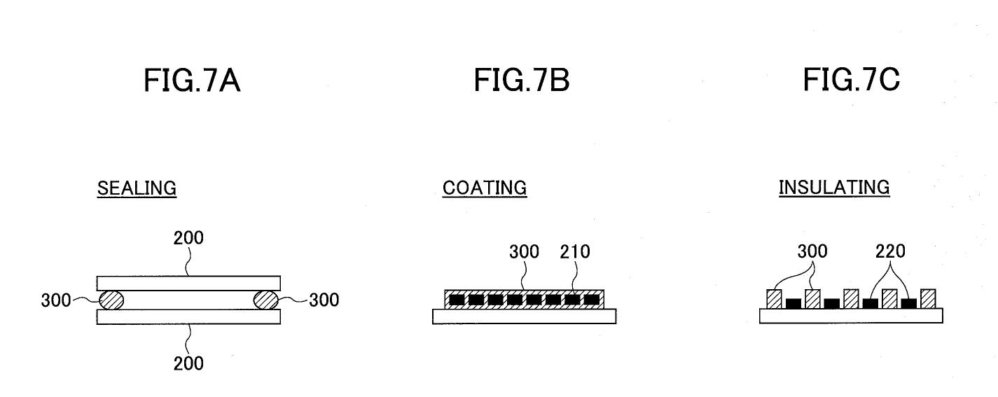

For example, the thermal spraying apparatus 1, 2 of the present embodiment and the modification can be applied to the thermal spraying to spray a material made of powdered glass (which is hereinafter called “fritted glass”) having a diameter of 0.1 through 10 μm. The fritted glass can be used for sealing (encapsulation and adhesion) of a display panel or various electronic components, coating, insulating and the like. For example, in FIG. 7A, two objects to be sprayed 200 are bonded and sealed. In addition, for example, in FIG. 7B, by coating electrodes 210 with fritted glass 300, lower surfaces of the electrodes 210 and the like are protected. In FIG. 7C, insulation between conductors 220 are maintained by fritted glasses 300.

Conventionally, when fritted glass was used for the intended purpose in FIG. 7A through 7C, firstly, an adhesive was mixed into powders of fritted glass and the mixed powders were knead to make a paste. Next, the paste was applied to an object to be processed, and then preliminarily firing and main firing were performed to fire the object to be processed. In the preliminary firing, the adhesive was removed by holding the object to be processed in a furnace heated at 300° C. for 1 through 2 hours. Next, in the main firing, the object to be processed was held in a furnace heated at 600° C. for about an hour until the fritted glass had effects of insulation and adhesion. In this method, two furnaces were required, and it took a few hours to perform the preliminary firing and the main firing.

On the other hand, in the thermal spraying apparatus 1, 2 of the present embodiment and the modification, fine-grained fritted glass is contained in the container 22, and the shaken fritted glass is melted by the heated gas supplied from the heating parts 30 and the melted fritted glass is sprayed on the object to be sprayed. By doing this, the fritted glass can be sprayed on a predetermined location of the object to be sprayed. Accordingly, a process of processing the fritted glass to a paste and an annealing process are not needed, by which processing time can be reduced from a few hours to seconds through tens of seconds, and the throughput can be improved. Moreover, because all of the thermal spraying process can be completed in the same processing chamber and a plurality of furnaces is not needed, a cost for constructing facilities can be reduced. Here, a location where the fritted glass is sprayed can be determined regionally by moving the stage 14 in accordance with instructions from the control part 100. Furthermore, since an adhesive is not required to be mixed into the fritted glass, a sprayed coating with a high purity of material can be formed.

### SECOND EXAMPLE OF APPLICATION

In addition, for example, the thermal spraying apparatus 1, 2 of the present embodiment and the modification can be applied to the thermal spraying using solder as a material. In general, the solder is used by melting bar-like solder by using an “iron.”

In contrast, in the thermal spraying apparatus 1, 2 of the present embodiment and the modification, the container 22 contains a compound of tin and lead having a diameter of 0.1 through 10 μm; the compound shaken off is melted by heated gas supplied from the heating parts 30; and the melted compound is sprayed onto an object to be sprayed. This makes it possible to form a solder contact by spraying the solder onto a predetermined location of the object to be sprayed. This allows processing time to be reduced to seconds through tens of seconds.

Here, even in spraying a material of the fritted glass or the compound of the tin and lead, the inside of the container 22 is preferably filled with an inactive gas or depressurized as well as a case of spraying the material made of metal. Moreover, the processing chamber 10 for decompression is preferably evacuated, and the thermal spraying is preferably performed under decompression environment. This can prevent oxygen or nitrogen in the air from mixing into the thermal coating.

As mentioned above, a description was given of a hopper and a thermal spraying apparatus according to embodiments of the present invention, but the hopper and the thermal spraying apparatus of the present invention are not limited to the above embodiments, and various modification and improvement could be made hereto without departing from the spirit and scope of the present invention.

For example, in the above embodiment and modification, the internal pressure of the container 22 is controlled to periodically become positive and negative based on a standard of 760 Torr (1 atm), but the present invention is not limited to this. The pressure control part 50, 51 may perform any pressure control as long as the pressure control part 50, 51 can create a periodic pressure difference inside the container 22.

Moreover, in the thermal spraying apparatus 1, 2 of the present embodiment and the modification, by blowing the heated gas from the heating parts 30, the material shaken from the hopper 20, 21 was sprayed onto the object to be sprayed while melting the material shaken from the hopper 20, 21. However, thermal spraying can be applicable that sprays the material as a cold spray without heating the gas, instead of using the heating parts 30.

Furthermore, the hopper and the thermal spraying apparatus according to an embodiment of the present invention may perform the thermal spraying by using heating by plasma. More specifically, it is preferable to choose the heating by heater for a material having a low melting point and to choose the heating by plasma for a material having a high melting point, depending on a melting point of metals or other materials. For example, when the material is solder, because the melting point is about 250° C. heating by the heater is preferable. When the material is powders of metal such as aluminum and the like, because the melting point is about 600° C., both of the heating by the heater and the plasma are possible.

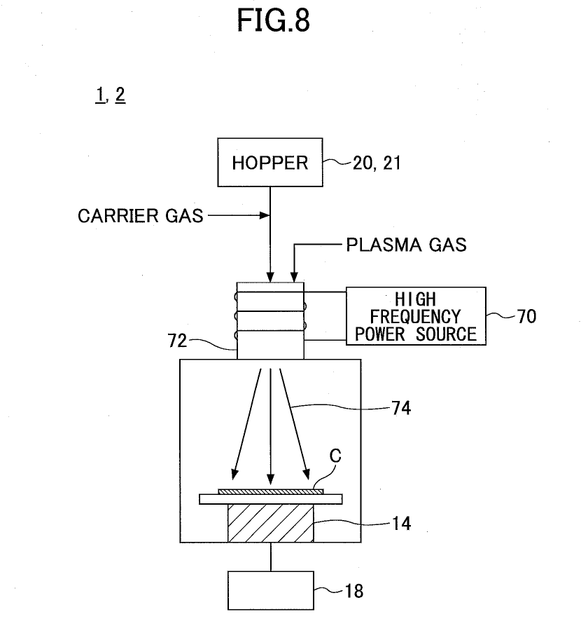

In the meantime, the heating by the plasma reaches about 1000° C. Accordingly, for example, since the powders of alumina and the like have a high melting point, the heating by the plasma is preferable. A simple description is given of a thermal spraying apparatus 1, 2 using the heating by the plasma with reference to FIG. 8. In FIG. 8, the hopper 20, 21 of the present embodiment or the modification is attached to the thermal spraying apparatus 1, 2. The fine-grained powders for thermal spraying are fed from the hopper 20, 21, and are carried by a carrier gas such as the argon gas and the like.

When an argon gas, a nitrogen gas or dry air is supplied to a torch part 72 as a plasma generation gas and high frequency power is supplied from a high frequency power source 70, an arc discharge 74 occurs from the torch part 72. This causes the powders for thermal spraying to be melted due to the heating of the plasma, and the melted powders for thermal spraying are sprayed onto an object to be sprayed C. As a result, a sprayed coating is formed on the object to be sprayed C. Here, the mechanism heating by the plasma is an example of the heating part 30 that heats the material carried by the carrier gas.

Thus, according to the embodiments of the present invention, a dense sprayed film can be formed by feeding a fine-grained material.

All examples recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority or inferiority of the invention. Although the embodiments of the present invention have been described in detail, it should be understood that various changes, substitutions, and alterations could be made hereto without departing from the spirit and scope of the invention.

What is claimed is:

1. A hopper comprising:
a container to contain a powdered material having a diameter of 0.1 through 10 micrometers, the container having a hole provided in a bottom thereof to feed the powdered material downward;
a pressure control part configured to create a periodic pressure difference inside the container; and
a vibration exciter configured to vibrate the container.

2. The hopper of claim 1, wherein the container includes an introduction port to introduce an inactive gas into the container. 25

3. The hopper of claim 1, wherein the pressure control part alternately switches a pressure in the container to a positive pressure in a range from (760+30) through (760+200) Torr and to a negative pressure in a range from (760−30) through (760−200) Torr.

4. The hopper of claim 3, wherein the pressure control part alternately switches the pressure in the container to a positive pressure in a range from (760+40) through (760+60) Torr and to a negative pressure in a range from (760−40) through (760−60) Torr.

5. The hopper of claim 1, wherein the pressure control part creates the pressure difference inside the container at a cycle of 1 through 10 Hz.

6. The hopper of claim 5, wherein the vibration exciter vibrates the container at a cycle of 1 through 100 Hz.

7. The hopper of claim 6, wherein the vibration exciter vibrates the container at a cycle of 5 through 50 Hz.

8. The hopper of claim 1, wherein the pressure control part creates the periodic pressure difference inside the container by controlling a switchover between inflow of a gas into the container and outflow of the gas from the container, a flow rate and a flow speed of the gas.

9. The hopper of claim 1, wherein the pressure control part creates the periodic pressure difference inside the container by an extendable pump-like member.

10. A thermal spraying apparatus comprising:
a container to contain a powdered material having a diameter of 0.1 through 10 micrometers, the container having a hole provided in a bottom thereof to feed the powdered material downward;
a pressure control part configured to create a periodic pressure difference inside the container;
a vibration exciter configured to vibrate the container;
a processing chamber to hold an object to be sprayed therein and provided below the container;
a material feeding part communicated with the hole of the container and an inside of the chamber; and
a heating part communicated with the inside of the chamber and configured to supply a heated gas to the powdered material fed from the container into the processing chamber through the material feeding part to melt and spray the powdered material onto the object to be sprayed.

11. The thermal spraying apparatus of claim 10, wherein the material feeding part includes a gas introduction port to introduce a carrier gas to carry the powdered material fed from the hole of the container into the chamber.

12. The thermal spraying apparatus of claim 10, further comprising:
an exhaust device configured to evacuate the processing chamber to a predetermined vacuum pressure.

13. The thermal spraying apparatus of claim 10, wherein an outlet of the heating part is located in the vicinity of an outlet of the material feeding part.

14. The thermal spraying apparatus of claim 13, further comprising:
one or more heating parts provided to surround the material feeding part with the heating part.
